(19) United States
(12) Patent Application Publication
(10) Pub. No.: US 2025/0002130 A1
(43) Pub. Date: Jan. 2, 2025

(54) TETHERED-WING TRACTION SYSTEM PROVIDED WITH A STAND HAVING INTERNAL STORAGE SPACE

(71) Applicant: AIRSEAS, Nantes (FR)

(72) Inventors: Eric Lamat, Mons (FR); Jean-Luc Haudebault, Francois (FR); George Wiel, Nantes (FR); Remi Retho, Nantes (FR)

(73) Assignee: AIRSEAS, Nantes (FR)

(21) Appl. No.: 18/711,978

(22) PCT Filed: Nov. 15, 2022
(86) PCT No.: PCT/EP2022/082025

§ 371 Date: May 21, 2024

(30) Foreign Application Priority Data
Nov. 24, 2021 (FR) FR2112464

(51) Int. Cl. B63H 9/072

(52) U.S. Cl. CPC B63H 9/072

(57) ABSTRACT

A tethered-wing traction system having: a traction wing (2); a trajectory control flying device (5); a base platform (8) on which a structure for deploying and folding the traction wing (2) is mounted; and a traction line. The traction system includes a stand (12) which includes a mounting base (13) on a traction support, this stand (12) further having an internal storage space (20) for the traction wing (2). The base platform (8) is rotatably mounted on the stand (12) via a pivot connection. The base platform (8) has a storage window opening into the internal storage space (20), this storage window being located at the foot of the deployment and folding structure.

### CROSS REFERENCE TO RELATED APPLICATION

This application is a National Stage Entry of PCT/EP2022/082025 filed Nov. 15, 2022, under the International Convention and claiming priority over French Patent Application No. FR2112464 filed Nov. 24, 2021.

### TECHNICAL FIELD

The invention concerns the field of tethered-wing traction systems that are adapted to deploy and to retract a traction wing relative to a base platform, this traction wing being adapted to generate a traction force because of the effect of the wind.

Such traction systems enable the deployment of a traction wing serving for the propulsion of a vehicle, in particular a ship (as main propulsion or propulsion assistance), for the production of electricity, or for any application benefitting from this kind of traction force.

### PRIOR ART

French patent application FR3082184 describes a tethered wing traction system and a method for deploying and retracting the traction wing. The system includes a structure for deploying and retracting the traction wing.

There exist means for orienting the traction wing relative to the apparent wind. These means generally impose temporary rerouting of the ship or necessitate complex and mobile devices within the deployment and retraction structure.

The prior art deployment and retraction methods generally include at least a certain number of manual steps necessitating the intervention of operatives near the deployment and retraction structure.

The French patent application FR3082185 describes another traction system with wings connected to a fixed post, this fixed post including a mast equipped with means dedicated to retracting the wings.

### SUMMARY OF THE INVENTION

The invention has the aim of improving prior art tethered wing traction systems and the associated deployment, retraction and storage methods.

To this end the invention is directed to a tethered wing traction system including:
a traction wing adapted to generate a traction force because of the effect of the wind;
a flying trajectory control device attached to the traction wing by suspension lines;
a base platform on which is mounted a structure for deploying and retracting the traction wing;
a traction line connecting the flying trajectory control device to the base platform.

Furthermore:
the system includes a stand which comprises a fixing base on a traction support, this stand further including an internal storage space for the traction wing;
the base platform is mounted to rotate on the stand by means of a pivot connection;
the base platform includes a storage window opening into the internal storage space, this storage window being situated at the base of the deployment and retraction structure.

Another object of the invention is directed to a method for deployment or retraction of a traction wing of a traction system as described hereinabove. This method includes a step of rotating the base platform on the stand to orient the deployment or retraction device relative to the wind.

This method may further include the following steps:
the carriages catch the traction wing by its suspension lines;
the carriages descend along the deployment and retraction structure into the internal storage space.

Here by traction support is meant an element on which a traction force is exerted to move it or a reference element to which the traction system is anchored. For example, in the situation where the traction system is intended for the production of energy, in particular electrical energy, the traction support may be the ground. In the situation where the traction system is intended for the propulsion of a vehicle the traction support is the vehicle itself.

A tethered wing traction system of this kind is compatible with total and safe automation of deployment and retraction of the traction wing. These operations can then be controlled from a remote-control station without necessitating human intervention on the traction system, to orient the traction wing, to manipulate the various ropes of the wing, or to aid folding or storage of the traction wing.

The traction wing may be oriented automatically (for example to present its leading edge facing into the apparent wind). The invention enables this orientation to be achieved by means of a simple pivot connection that is more reliable and less costly than other complex devices for orienting the structure for deploying and retracting the traction wing.

All the elements intended to manipulate the traction wing are preferably mounted on the base platform, such as for example traction line winches, supports for the elements of the traction wing, etc. All these elements mounted on the base platform are driven in rotation conjointly with the deployment and retraction structure so that no complex mechanical connection need to be provided between these various elements present in the same physical frame of reference.

The angular orientation of the deployment and retraction structure, which enables adjustment of the position of the traction wing relative to the wind, is therefore effected independently of the traction support.

In the situation of mounting the traction wing on a vehicle such as ship it is not necessary, as in some prior art implementations, to orient the ship itself to achieve the required orientation of the traction wing, which implies rerouting the ship during deployment and retraction phases. The possibility of orienting all of the hardware present on the base platform, including the structure for deploying and retracting the traction wing, without rerouting the ship, is particularly advantageous in the case of large ships that are not very maneuverable, such as container ships or oil tankers. This orientation possibility further offers opportunities for combination with the route of the ship to cause the intensity of the apparent wind to vary (for example by adding the speed of the ship to the true wind speed).

The stand enables angular orientation of the base platform and the deployment and retraction structure. This stand preferably further enables placement of the base platform at a sufficient height for the deployment and retraction structure to be out of range of external disturbing elements. For example, in the case of mounting the traction system on a ship the stand further procures a higher elevation enabling less exposure to big waves of the elements present on the base platform, that is to say less exposure to the high masses of water that impact the deck of a ship under certain difficult weather conditions.

Furthermore, the base platform does not include on its surface any element for storing the traction wing, those elements being the most critical in the case of exposure to big waves, because these storage elements have large plane surfaces and are therefore subjected to high pressures under such weather conditions. The traction wing is stored under shelter in the stand close to the deck of the ship, the shape of which is preferably chosen to have a lower resistance (a cylindrical shape for example).

The increased height procured by the stand further makes it possible to place the traction wing itself outside areas of fluid turbulence caused by the presence of elements of the ship interfering with the wind (superstructures of the ship, containers, diverse loads, etc.). During these deployment and retraction phases the traction wing therefore benefits from a not much disturbed flow of wind, closer to a laminar flow. Such wind conditions with little disturbance are advantageous for employing entirely automated maneuvering or folding methods and for executing certain advanced processes such as wind sail folding, favoring the deployment of the traction wing.

The stand further makes it possible to reduce the footprint of a tethered wing traction system by choosing a stand section with dimensions less than the dimensions of the base platform.

The stand integrates storage for the traction wing in its structural foundation. The traction wing is therefore no longer stored in elements external to the base platform (or placed on the base platform) which, in addition to the protection functions mentioned above, makes it possible to facilitate entirely automated stowage of the traction wing.

The storage window opening into the internal storage space is located at the base of the deployment and retraction structure so that the wing can be manipulated by simple mobile elements (carriages sliding on rails, for example) and deposited directly in its storage space by following a simple and direct trajectory.

The traction system in accordance with the invention may have the following additional features, separately or in combination:
the base platform includes a support for the flying trajectory control device arranged at the periphery of the storage window;
the system includes a winch mounted on the base platform adapted to wind in or to release the traction line;
the system includes a storage neck formed of a cylinder portion providing access to the storage window, this cylinder being fixed to the base platform;
the system includes a guide funnel in the direction of the storage window for folding the traction wing;
the guide funnel includes a guide hook for guiding the suspension lines of the traction wing;
the storage neck includes a notch through which the suspension lines of the traction wing pass;
the system includes a cover for closing the storage neck;
the deployment and retraction structure passes through the storage window;
the cover includes a cut-out through which the deployment and retraction structure passes;
the system includes a wing receptacle that is attached to the base platform and arranged in the internal storage space;
the wing receptacle includes an upper opening fixed by its perimeter to the internal walls of the storage neck;
the system includes means for driving in rotation a lower part of the wing receptacle;
the wing receptacle includes a lateral opening for access to the deployment and retraction structure;
the system includes a device for driving rotation of the base platform on the stand including a toothed ring with which at least one gear meshes;
the system includes retaining blocks for holding the base platform against the stand;
the system includes a retaining leg structure connecting the deployment and retraction structure to the base platform over the storage window;
the guide funnel is formed of at least one barrier attached to the retaining leg structure;
the deployment and retraction structure includes a mooring mast fixed to the base platform and adapted to moor the traction wing by its leading edge;
the deployment and retraction structure includes carriages for manipulating the suspension lines, said carriages being adapted to slide along the mooring mast into the internal storage space.

### BRIEF DESCRIPTION OF THE FIGURES

Other features and advantages of the invention will emerge from the following non-limiting description with reference to the appended drawings in which:

FIG. 1 depicts a traction system in accordance with the invention, the traction wing being in flight;

FIG. 2 depicts the traction system from FIG. 1, the traction wing being in the process of being deployed or retracted;

FIG. 3 represents the base platform and the deployment and retraction structure of the traction system in accordance with the invention;

FIG. 4 is a schematic view in section of the traction system in accordance with the invention;

FIG. 5 depicts the base platform of the traction system in accordance with the invention;

FIG. 6 represents a portion of the traction system in accordance with the invention seen from above;

FIG. 7 represents the wing receptacle of the traction system in accordance with the invention;

FIG. 8 represents the portion of the traction system depicted in FIG. 6 seen from below;

FIG. 9 is a detailed view of the traction system in accordance with the invention;

FIG. 10 represents the base platform of the traction system in accordance with the invention seen from below and in perspective;

FIG. 11 represents the base platform of the traction system in accordance with the invention seen from below;

FIG. 12 depicts the base platform of the traction system in accordance with the invention with one half-cover open;

FIG. 13 depicts the base platform of the traction system in accordance with the invention with the other half-cover open;

FIG. 14 is a schematic view in section of the traction system in accordance with the invention depicting the deployment or retraction process.

### DETAILED DESCRIPTION OF THE INVENTION

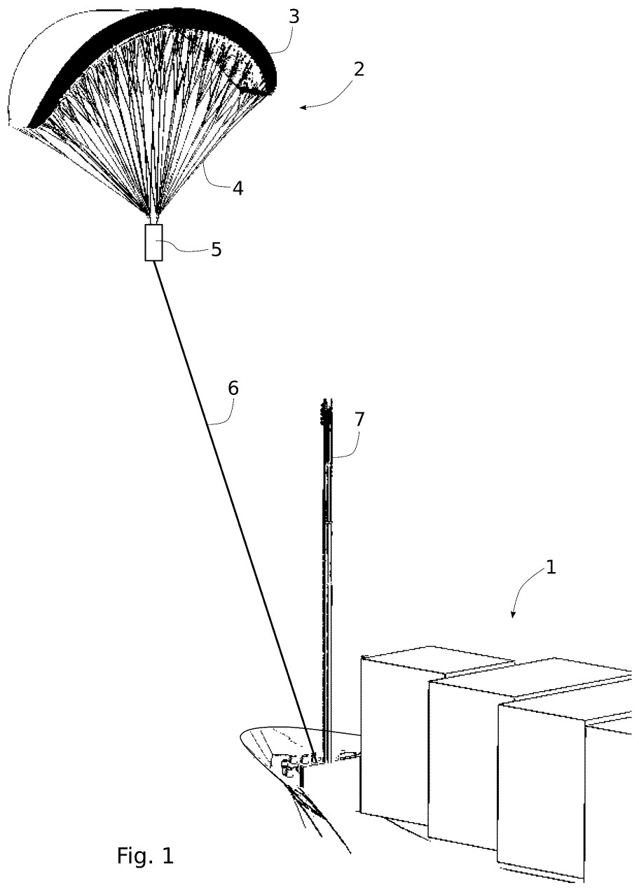

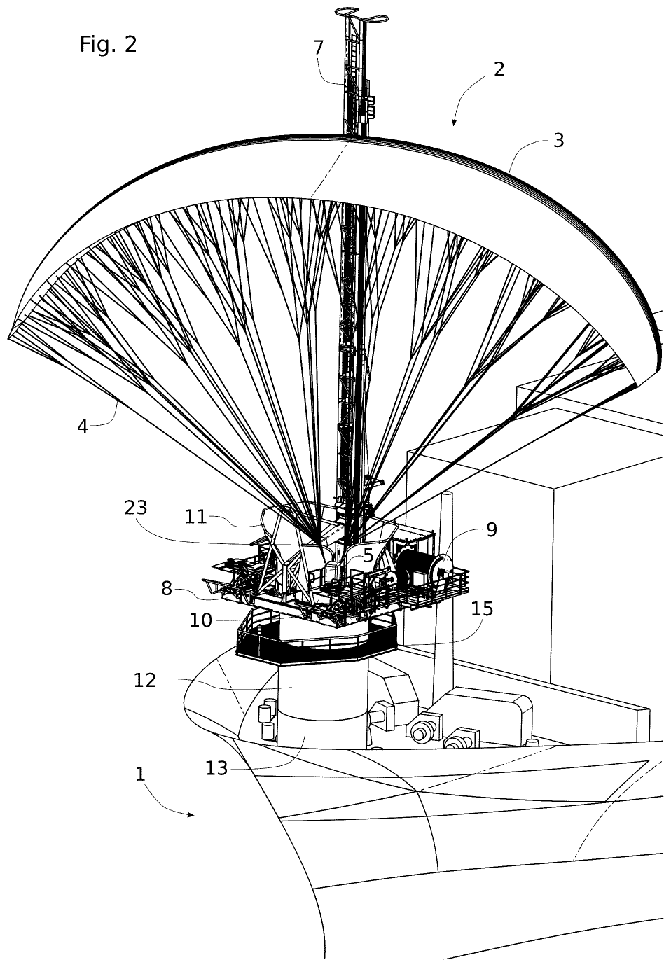

FIGS. 1 and 2 depict a tethered wing traction system mounted on a ship 1 which in this example is a seagoing cargo ship (in these figures only the bow of the ship has been represented).

In the present example the traction system is mounted on the prow of the ship 1 and is actuated as a complementary means for propulsion of the ship enabling fuel saving. In this context the traction system has dimensions according to the tonnage of the ship to be towed and is designed to be deployed and retracted automatically.

This traction system can alternatively be used for any other application in which this kind of traction system deployable and retractable automatically is required, for example as the main propulsion means of a ship, for the propulsion of any other vehicle, for the production of electricity, etc.

The retraction system includes a traction wing 2 that is adapted to generate a traction force because of the effect of the wind. In the present example the traction wing 2 is a parafoil-type wing. Any other flying equipment adapted to generate a traction force because of the effect of the wind may be employed instead, such as kites, equipment for gliders, “kite” type wings, etc. The traction wing 2 conventionally includes a leading edge 3 intended to be exposed to the incident wind.

The traction wing 2 is connected by a set of suspension lines 4 to a flying trajectory control device 5 that is adapted to act on the suspension lines 4 to control the flight of the traction wing 2.

In FIG. 1 the traction system is in a traction configuration, with the traction wing 2 deployed and in flight and with the system participating in the propulsion of the ship 1. FIG. 2 depicts the same traction system during a deployment or retraction phase.

The traction system further includes a traction line 6 enabling the traction force to be exerted on the ship to propel it. The traction line has dimensions chosen accordingly. In the framework of towing a seagoing cargo ship the traction line may for example be a textile cable the diameter of which can be as much as several centimeters.

The flying trajectory control device 5 enables control of the flight of the traction wing 2 in order to orient and to position the traction wing and possibly to drive the traction wing 2 to trace out flight figures enabling the traction force exerted on the ship to be increased. Here the trajectory of the traction wing 2 is controlled by controlling the length of certain mobile suspension lines in the manner that is conventional in the field of kites.

For example, the set of suspension lines 4 includes fixed suspension lines (that is to say lines that have a fixed length between their attachment to the traction wing 2 and their attachment to the flying trajectory control device 5) and mobile suspension lines the length of which is variable. The flying trajectory control device 5 is adapted to pull on certain mobile suspension lines and/or to release other mobile suspension lines so that the aerodynamic profile of the traction wing 2 is modified in order to control its lift, its trajectory, etc. The modification of the profile of a traction wing to control is trajectory is effected in the convention manner and will not be described in more detail here.

The traction system further includes a structure for deploying and retracting the traction wing. In the present example this structure includes a mooring mast 7 extending vertically. The mooring mast 7 enables the traction wing 2 to be caught, held and oriented during deployment and retraction phases. FIG. 2 shows an example of one of these phases, in which the traction wing 2 is inflated by the wind with its leading edge held against the mooring mast 7. This position precedes launching the wing (during deployment phases) or to the contrary precedes folding the wing (during retraction phases). The mooring mast 7 may include carriages provided with hooks and mobile in translation along the mooring mast 7 so as to be able to catch the suspension lines 4 of the traction wing and to enable execution of any appropriate deployment and retraction process. The suspension lines 4 may have mooring, furling or folding line functions, for example.

Alternatively, any other deployment and retraction structure may be used that enables catching and manipulation of the lines of the traction wing, preferably automatically. Likewise, attachment means other than carriages may be provided.

The traction system further includes a base platform 8 to which the traction wing 2 is attached by means of the traction line 6. A winch 9 is mounted on the base platform 8. The traction line 6 is connected to the base platform 8 by means of this winch 9 which is driven by a motor, for example an electric or hydraulic motor.

The winch 9 is adapted either to unwind the traction line 6 to enable the traction wing 2 to rise to altitude or on the contrary to wind in the traction line 6 to draw the traction wing 2 toward the base platform 8.

The base platform 8 further includes a support 10 for the flying trajectory control device 5 intended to receive that device during deployment, retraction and storage phases.

The base platform 8 further includes a guide funnel 11 adapted to guide the traction wing 2 toward its storage space without damage during retraction phases.

The base platform 8 is a functional infrastructure supporting the elements for handling the traction wing 2 (such as the winch 9, the guide funnel 11 and the support 10) and may further include floors and catwalks enabling access to this equipment, in particular for maintenance and inspection. The corresponding guard rails and any other safety elements are also mounted on the base platform 8.

The traction system further includes a stand 12 on which the base platform 8 is mounted. In the present example the stand 12 consists of a cylindrical barrel including a mounting base 13 that enables the stand 12 (and therefore the whole of the traction system) to be fixed onto its traction support. In the present example the traction support is the ship 1 on which the traction system will act. In other examples, for example when the traction system is intended for the production of electricity, the traction support may be a fixed element connected to the ground.

The mounting base 13 is therefore the final element by which the traction force is transmitted from the traction wing 2 to the ship. This mounting base 13 is for example welded or bolted to the deck of the ship 1.

In the present example the traction system has an overall width of approximately 15 meters (this dimension corresponding to the maximum width of the base platform 8) while the diameter of the stand 12 is approximately 5 meters. Here the footprint of the system is reduced by two thirds thanks to the stand 12.

The base platform 8 is mounted to rotate on the stand 12 by means of a pivot connection. In the present example the pivot axis 14 is perpendicular to the base platform 8. The mooring mast 7 furthermore extends along an axis that is parallel to this rotation axis of the base platform 8.

Rotation of the base platform 8 on its stand 12 therefore drives rotation of the mooring mast 7 (or of any other deployment or retraction structure mounted on the base platform 8). During deployment or retraction phases (as depicted in FIG. 2) the traction wing 2 may be held against the mooring mast 7 by its leading edge 3. The rotation of the base platform 8 then enables conjoint orientation of the traction wing 2, the mooring mast 7 and all the wing manipulation elements (winch 9, support 10, guide funnel 11, etc.) to orient the traction wing 2 in the required angular position relative to the apparent wind. In particular, the leading edge 3 of the traction wing 2 can therefore be oriented facing into the apparent wind.

Here the stand 12 further includes an inspection catwalk 15 enabling personnel to circulate around the barrel constituting the stand 12 and under the base platform 8 to enable maintenance and inspection operations. The inspection catwalk 15 is advantageously circular and enables access to the system regardless of the angular position of the base platform 8 thanks to a ladder for accessing the base platform 8, which can be joined to the inspection catwalk 15 over the whole of the possible angular amplitude.

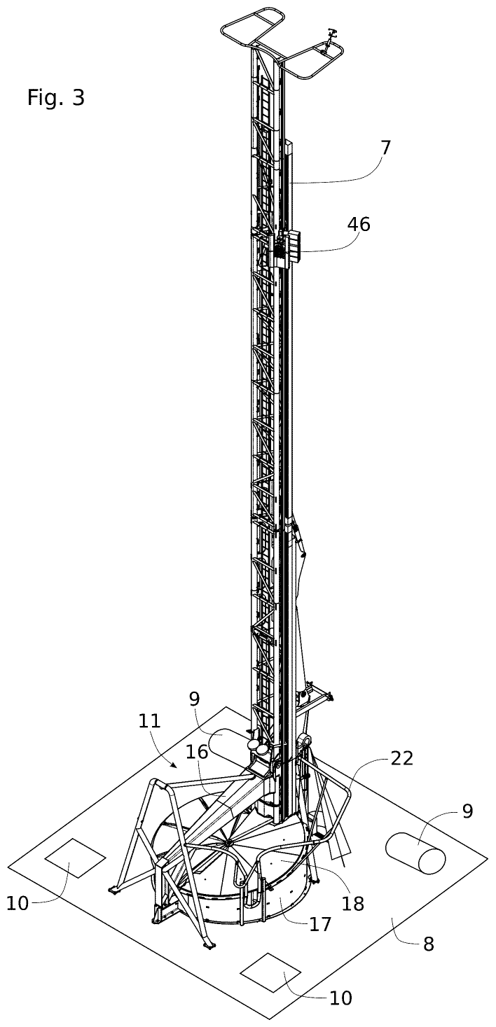

FIG. 3 is a perspective view showing the deployment and retraction structure and the base platform 8 of the traction system.

In the present example the traction system is a system with two traction wings. It is designed to deploy two traction wings 2 simultaneously or alternately from the same mooring mast 7.

The mooring mast 7 includes as many elements for manipulating the traction wing (rails, guide elements, etc.) as necessary, these elements being arranged symmetrically to serve independently each of the two traction wings that are manipulated. In FIG. 3 carriages 46 sliding along the mooring mast 7 depict such elements for guiding the traction wing 2.

The dual traction system includes, symmetrically, two winches 9 each winding in and releasing the traction line 6 of each traction wing and two supports 10 for the flying trajectory control device 5 of each traction wing 2.

The mooring mast 7 is mechanically fixed to the base platform 8 and further includes a retaining leg assembly 16 that straddles a storage neck 17 situated at the base of the mooring mast 7.

The storage neck 17 is fixed to the base platform 8 and here consists of a cylindrical wall including a cover 18. When the cover 18 is open the storage neck 17 provides access to an internal storage space provided in the stand 12.

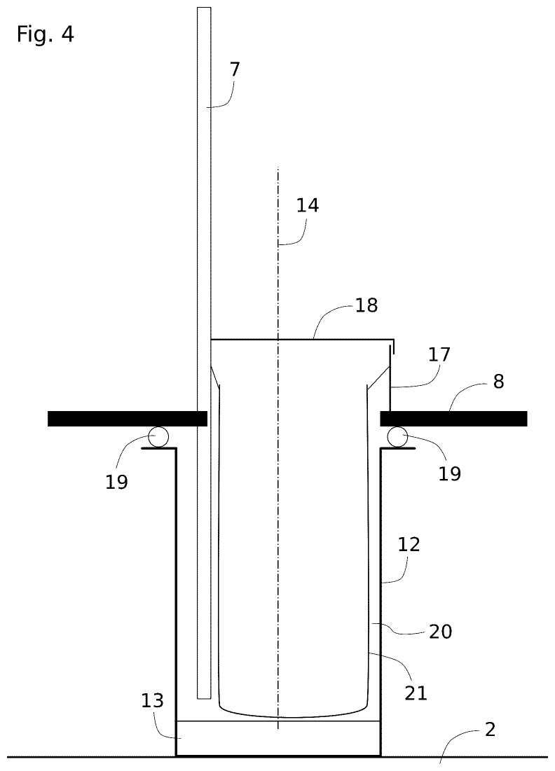

FIG. 4 is a functional section of the elements from FIG. 3.

The stand 12 is fixed to the deck of the ship 1 by its mounting base 13 and is connected at its upper end to the base platform 8. However, the mounting base 13 may instead simply consist of the bottom of the stand 12.

The pivot connection between the base platform 8 and the stand 12 is schematically represented by the bores 19 and the rotation axis 14 of the base platform 8 relative to the stand 12 is represented in dashed line.

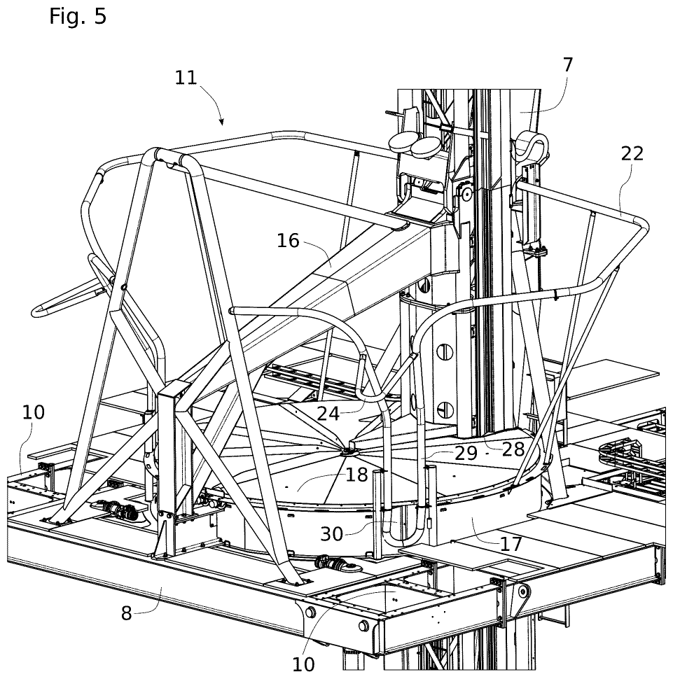

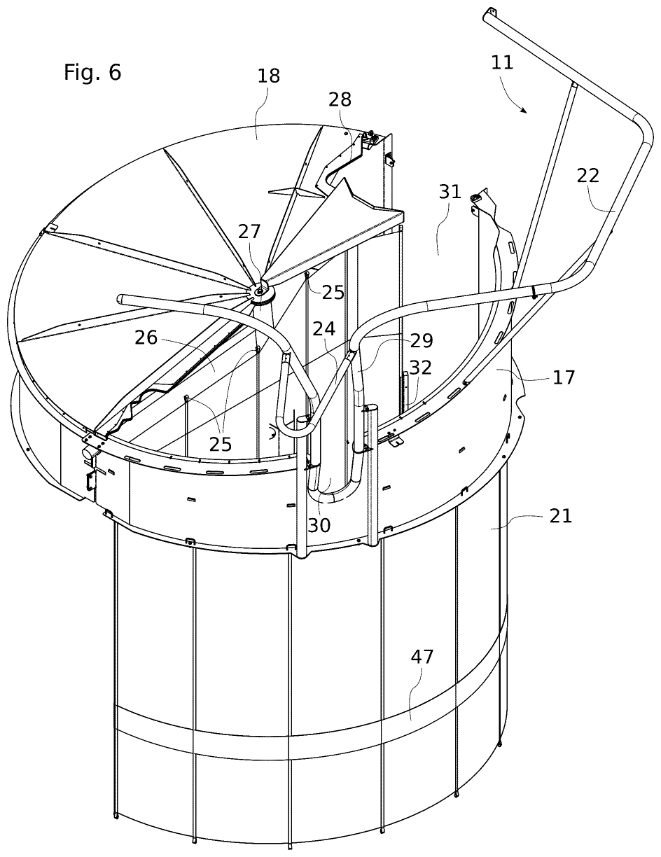

The base platform 8 includes a circular storage window 45 that opens into an internal storage space 20. The storage window 45 is situated at the base of the mooring mast 7. The guide funnel 11 (see FIGS. 5 and 6) forms a funnel extending in the direction of the storage window 45.

The support 10 of the flying trajectory control device 5 is arranged on the base platform 8 at the periphery of the storage window 45.

The pivot connection between the base platform 8 and the stand 12 may be provided by any element enabling the base platform 8 to rotate on the stand 12, such as ball bearings, sliding tracks, etc.

The mooring mast 7 is fixed to the base platform 8 and likewise the storage neck 17 with its cover 18. The mooring mast 7 passes through the storage window 45 and extends both above and below the platform 8.

The stand 12 is hollow and delimits an internal storage space 20 intended for storing the traction wing 2 and protecting it when it is not being used. The storage window 45 provides access to this internal storage space 20.

The stand 12 further has a height (for example of the order of 6 meters) enabling the deployment and retraction structure to be placed outside areas in which the flow of the wind is disturbed by loading or structural elements of the ship.

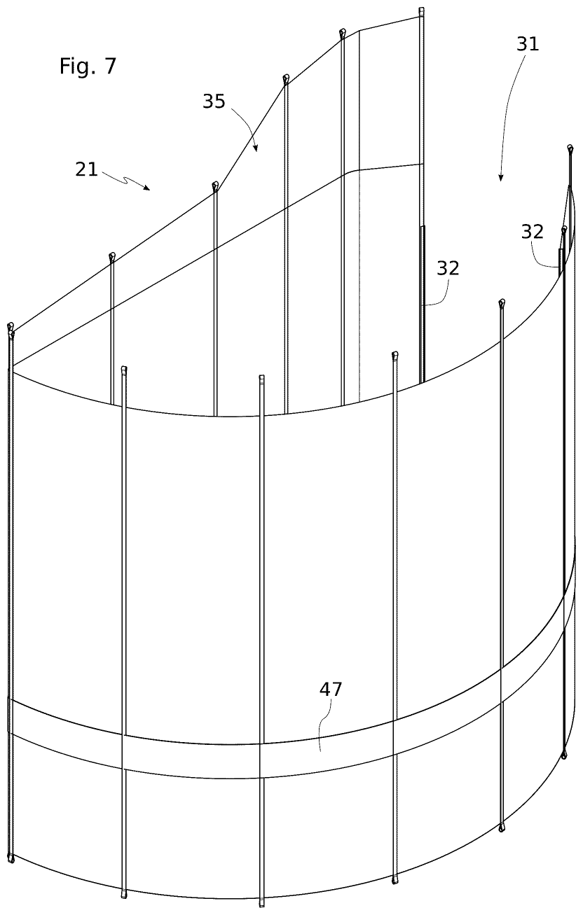

In the present example the traction system includes a wing receptacle 21 with an upper opening 35 (see FIG. 7). The upper opening 35 is fixed by its perimeter to the internal walls of the storage neck 17 so that the traction wing 2 can be stored in the internal storage space 20 inside the wing receptacle 21 after a folding phase.

The base platform 8, the mooring mast 7, the storage neck 17 and the wing receptacle 21 form an assembly of elements constrained to rotate together. This assembly turns conjointly with the base platform as it rotates on the stand 12.

FIG. 5 is a view to a larger scale showing the top of the base platform 8.

The leg assembly 16 connects the mooring mast 7 to the base platform 8, passing over the storage window 45.

In this dual traction wing traction system example the leg assembly 16 divides the space of the base platform 8 into two symmetrical parts including the same elements on each side. The internal storage space 20 of the stand 12 therefore includes two wing receptacles 21 inserted in the internal storage space 20 of the stand 12 and each having a semi-cylindrical shape.

The cover 18 includes two rotating half-covers enabling the storage neck 17 to be opened on either side of a diameter. The first traction wing is therefore stored by passing it through one half of the storage neck 17, from one side of the leg assembly 16, and the other traction wing 2 is stored by passing it through the other half of the storage neck 17, on the other side of the leg assembly 16.

Going beyond the example described here, the traction system in accordance with the invention may of course include only one traction wing.

For each of the traction wings the system includes a barrier 22 that here is formed of welded tubes. Each barrier 22 extends around the storage half-neck 17 corresponding to one traction wing, surrounding it and defining a flared shape forming a funnel. A textile 23 or a net (see FIG. 2) is tensioned between the tubes forming the barrier 22 so as to form a funnel adapted to drive the traction wing being retracted toward the storage neck 17, protecting the sailcloth of the traction wing 2 from any damage.

The barrier 22 is also attached to the leg assembly 16.

Furthermore, the barrier 22 further includes a guide hook 24 (here also formed by shaped tubes) arranged in vertical alignment with the corresponding support 10 and oriented toward the latter. This guide hook 24 has a retaining rim function intended to channel and to hold all the suspension lines 4 when the traction wing 2 is stored inside the stand 12.

FIG. 6 is a perspective view of the storage neck 17 on its own and of the barrier 22 of one traction wing.

The wing receptacle 21 is attached to the storage neck 17 by its upper opening 35 the perimeter of which is attached by straps 25 to the internal walls of the storage neck 17. The storage neck 17 further includes beams 26 or any other wall element diametrically dividing the storage neck 17 in two and also enabling attachment of the straps 25.

In FIG. 6 the cover 18 is open. One of the half-covers constituting it has pivoted under the other half-cover. These half-covers are mounted to rotate on a central shaft 27, at two different heights on this central shaft 27, so that each half-cover can be retracted by passing below or above the other half-cover, to provide access to one or the other of the wing receptacles 21 (in FIG. 6 only one wing receptacle 21 has been represented).

The two half-covers constituting the cover 18 each further include a cut-out 28 enabling the mooring mast 7 to pass through them. The cover 18 is therefore closed against the mooring mast 7. A seal (or other means having the same function) may be provided at the level of the contact between the cover 18 and the mooring mast 7 to prevent water entering the internal storage space 20.

The tubes of the barrier 22 further form a guide path 29 toward the storage neck 17. The guide path 29 extends between the guide hook 24 and a notch 30 in the wall of the storage neck 17.

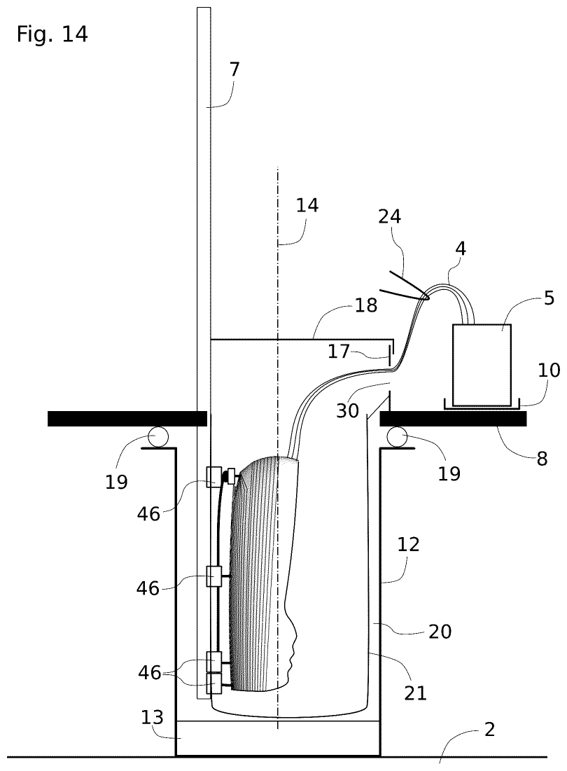

When a traction wing 2 is stored inside the stand 12 and the cover 18 is closed the suspension lines 4 exit the internal storage space 20 via the notch 30, are then held by the guide hook 24 and then rejoin the flying trajectory control device 5 that is fixed to its support 10 (see FIG. 14, which is a view similar to FIG. 5 with the traction wing 2 in the storage position).

FIG. 7 depicts one of the wing receptacles 21 on its own. Here the wing receptacle 21 is a flexible material bag adapted to contain the traction wing without damaging it. The wing receptacle may preferably consist in whole or in part of a perforated textile (a net for example) to allow air to pass through it to enable drying of the traction wing 2 after stowing it. Alternatively, the wing receptacle 21 may consist of a more or less flexible sealed material pocket or a rigid compartment, made for example of a composite material.

Furthermore, the internal storage space 20 may further include a ventilation or air extraction device in order further to favor the drying of the traction wing 2.

The wing receptacle 21 includes a friction reinforcement 47 intended to prevent it from rubbing against the internal walls of the internal storage space 20 when the base platform 8 turns relative to the stand 12.

The wing receptacle 21 further includes a lateral opening 31 enabling the traction wing 2 during its retraction phase to be guided along the mooring mast 7 as far as the interior of the wing receptacle 21. The mooring mast 7 is fixed to the base platform 8 and extends below said base platform 8 so as to be arranged facing this lateral opening 31. The lateral opening 31 therefore provides access to the deployment and retraction structure.

The wing receptacle 21 includes on the rims of the lateral opening 31 bolt ropes 32 for attaching the wing receptacle 21 to the mooring mast 7 or elements (fairing elements, for example) connected to the mooring mast 7. The bolt ropes 32 are inserted in corresponding profile members arranged along the mooring mast 7 (or any other element connected to the mooring mast 7).

During rotation of the base platform 8 on the stand 12 the wing receptacle 21 is retained along the mooring mast 7 and driven in rotation but without interfering with the rotation of the mooring mast 7. Furthermore, elements such as the carriages 46 for handling the lines of the traction wing 2 are able to slide freely along the mooring mast 7 to deposit the wing in the wing receptacle 21, entering the lateral opening 31, between the two bolt ropes 32.

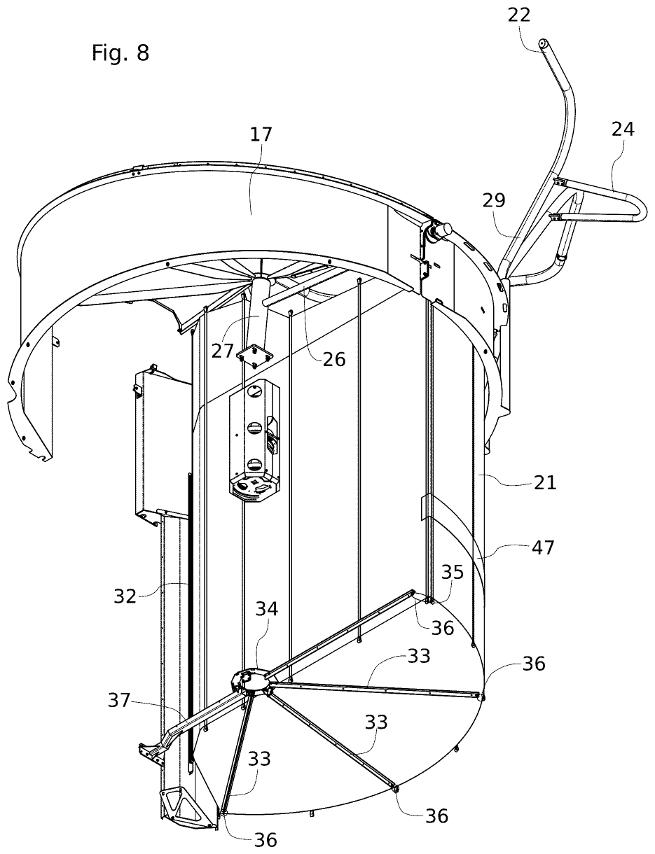

FIG. 8 is a view similar to FIG. 6 seen from below.

The underside of the wing receptacle 21 is driven in rotation conjointly with the rest of the wing receptacle 21 to avoid any phenomenon of twisting of the wing receptacle 21 during rotation of the base platform 8.

The underside of the wing receptacle 21 is therefore connected to rotation drive means here including bars 33 fixed to a central ring 34 and connected to loops 36 at the level of the lower rim of the wing receptacle 21. The central ring 34 is rigidly connected by a main arm 37 to the mooring mast 7 (or to any other element fastened to the base platform 8). The assembly can optionally be stiffened by interconnecting the bars 33 by means of cables.

During driving in rotation of the platform 8 the storage neck 17 drives in rotation the upper part of the wing receptacle 21 and the bars 33 drive its lower part in rotation conjointly with the base platform 8 and the mooring mast 7.

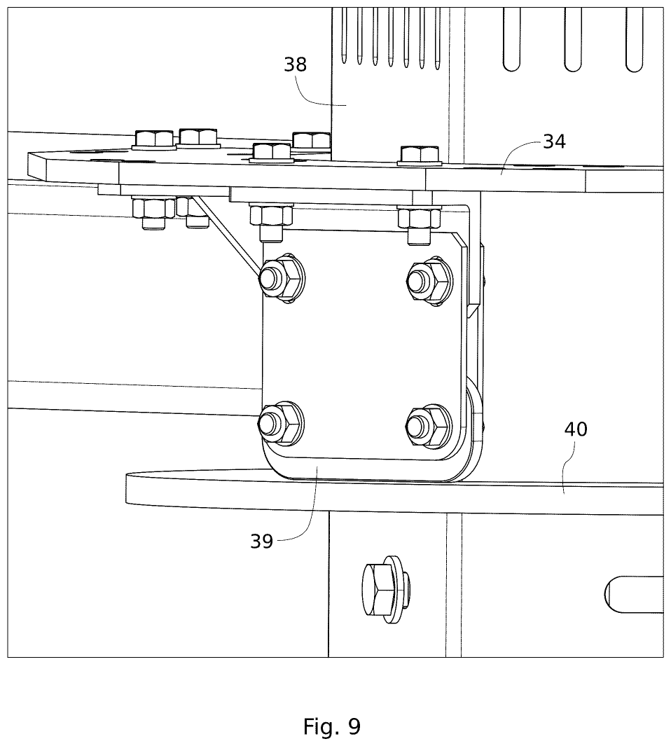

FIG. 9 depicts one option for mounting the central ring 34. The central ring 34 is arranged around a central beam 38 fastened to the stand 12 and rests via sliding shoes 39 on a flange 40 fastened to the central beam 38. This produces a pivot connection between the central ring 34 (and therefore the bars 33) and the stand 12.

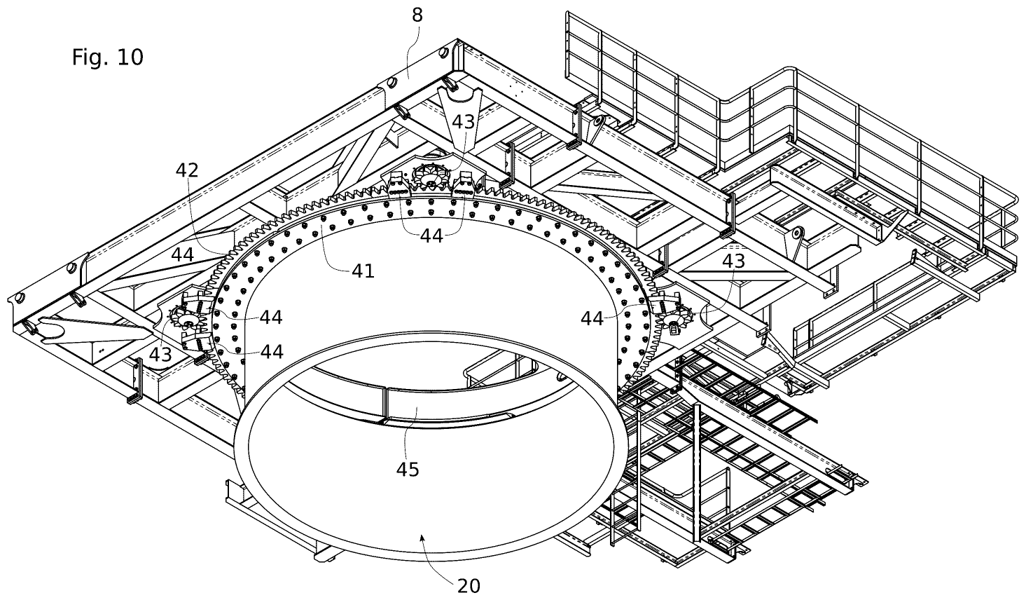

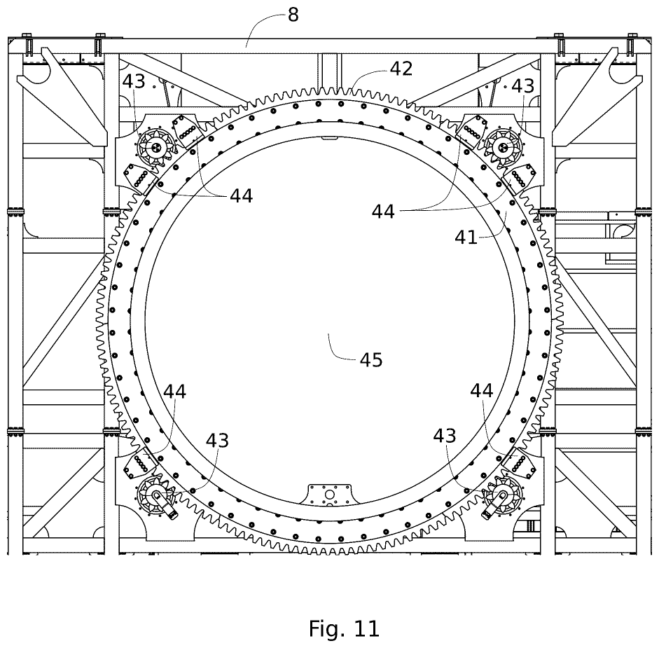

FIGS. 10 and 11 depict one embodiment of the pivot connection between the base platform 8 and the stand 12 and the system for driving the aforementioned rotation.

In FIG. 10 the stand 12 has been represented without its fixing base 13, the internal storage space therefore being visible (the fixing base 13 and the rest of the stand 12 can be bolted, welded, etc.).

The stand 12 includes an upper flange 41 extending over the periphery of the barrel constituting the stand 12. A toothed ring 42 is fixed (here bolted) to this upper flange 41 and the assembly is connected to the base platform 8 by sliding or rotation means.

FIG. 11 is a view of the elements from FIG. 10 seen from below.

In the present example the base platform includes four gears 43 meshing with the toothed ring 42 and driven conjointly to drive rotation of the base platform 8 on the stand 12. The motors driving the gears 43 are mounted on the base platform 8.

Retaining blocks 44 mounted on the base platform 8 hold the base platform 8 against the toothed ring 42.

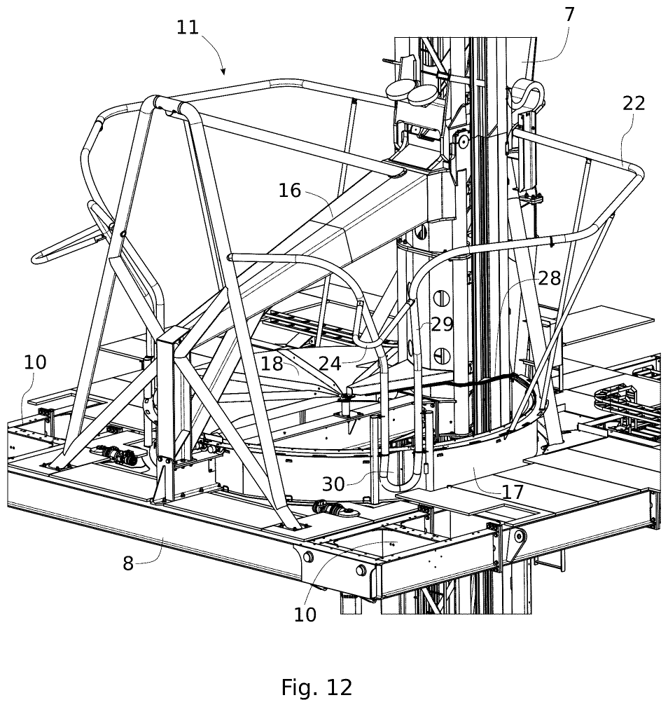

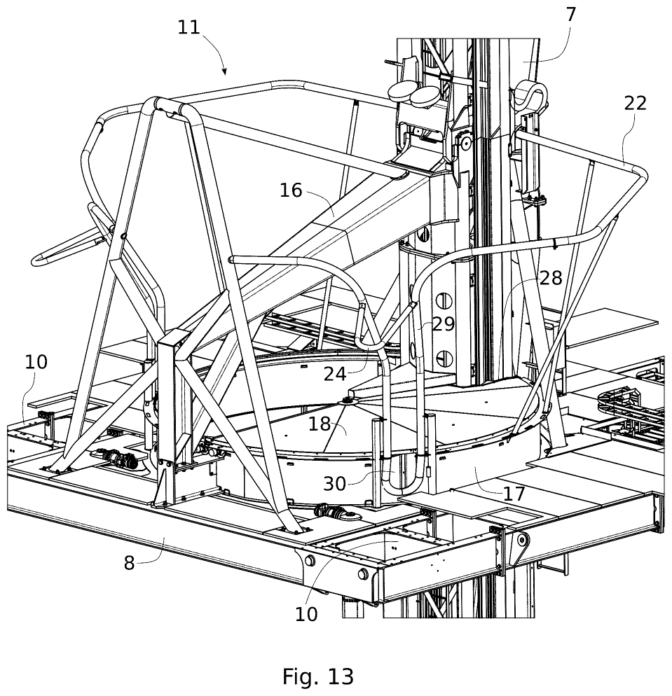

FIGS. 12 and 13 depict sequences of actuation of the cover 18. The cover 18 may be driven by any appropriate means. In the present example this necessitates only one motor which drives in rotation only one of the half-covers (the cover 18 consisting of two half-covers). Means for coupling the two half-covers in rotation are moreover provided so that the motorized half-cover is able to drive the passive half-cover.

FIG. 12 depicts the opening of the cover 18, the right-hand half-cover being open. The traction wing situated on the right-hand side in the figure can therefore be deployed or retracted.

Only this right-hand half-cover is motorized. If it is required to open the left-hand half-cover from the FIG. 12 position, a means for coupling the two half-covers in rotation (for example an electromagnetic latch) is activated.

The right-hand half-cover is then activated again in rotation to return to its initial position on the right-hand part, entraining with it in rotation the second half-cover of the left-hand part, resulting in the open position of FIG. 13.

The two half-covers can therefore be driven by a single drive system. Alternatively, each half-cover may have its own independent drive system.

FIG. 14 depicts the method of retracting the traction wing 2 and represents the final retraction phase.

The method of retracting the traction system consists of the following operations:
starting from the flight position in FIG. 1, the traction wing 2 is winched in by the winch 9 until it is near the mooring mast 7;
the base platform 8 is driven in rotation on the stand 12 so that the mooring mast 7 is angularly oriented to be positioned facing into the apparent wind;
the leading edge 3 of the traction wing 2 is moored against the mooring mast 7 (by a dedicated mooring line or by any other known means);
carriages 46 catch various lines of the traction wing 2 and fold the traction wing 2 along the mooring mast 7;
the cover 18 is opened;
the carriages 46 then descend along the mooring mast 7 and pass through the storage neck 17 and the storage window 45 until the traction wing 2 is placed inside the wing receptacle 21 (the guide funnel 11 channeling the traction wing toward the storage neck 17);
the cover 18 is closed.

The traction wing 2 is therefore safely stored in an orderly manner inside the wing receptacle 21 in an entirely automated manner and continues to be retained by the carriages 46. During these retraction operations the suspension lines 4 of the traction wing 2 are guided as they move between the traction wing 2 in storage and the flying trajectory control device 5 on its support 10, also in an automated manner.

During phases of deploying the traction wing 2 these operations are repeated in reverse order, the wing then exiting the wing receptacle 21 by virtue of the upward sliding of the carriages along the mooring mast 7 and the base platform 8 being driven in rotation so that the mooring mast 7 is arranged at an angle such that it faces into the apparent wind, thereafter to enable the traction wing 2 to fly (see FIG. 2).

Variant embodiments of the traction system may be used. In particular, the deployment and retraction structure may include elements additional to or as alternatives to the mooring mast 7, such as deployable or foldable structures, etc.

Furthermore, the base platform 8 need not have a wing receptacle 21, the wing then being stored directly in the internal storage space 20 with no receptacle and being retained only by the carriages 46. In this case the internal walls of the stand 12 are preferably free of sharp edges and may include arrangements (coatings, etc.) for protecting the traction wing in the event of it rubbing on the internal walls of the stand 12 during rotation of the platform 8 on the stand 12.

1. A tethered wing traction system comprising:
a traction wing (2) adapted to generate a traction force because of the effect of the wind;
a flying trajectory control device (5) attached to the traction wing (2) by suspension lines (4);
a base platform (8) on which is mounted a structure for deploying and retracting the traction wing (2);
a traction line (6) connecting the flying trajectory control device (5) to the base platform (8);
a stand (12) which comprises a fixing base (13) on a traction support, the stand (12) further including an internal storage space (20) for the traction wing (2);
the base platform (8) is mounted to rotate on the stand (12) by a pivot connection;
the base platform (8) includes a storage window (45) opening into the internal storage space (20), the storage window (45) being situated at the base of the deployment and retraction structure.

2. The traction system as claimed in claim 1, wherein the base platform (8) includes a support (10) for the flying trajectory control device (5), the support (10) being arranged at the periphery of the storage window (45).

3. The traction system as claimed in claim 1, further including a winch (9) adapted to wind in or to release the traction line (6), the winch (9) being mounted on the base platform (8).

4. The traction system as claimed in claim 1, further including a storage neck (17) formed of a cylinder portion providing access to the storage window (45), the cylinder being fixed to the base platform (8).

5. The traction system as claimed in claim 1, further including a guide funnel (11) for folding the traction wing (2) extending in the direction of the storage window (45).

6. The traction system as claimed in claim 5, wherein the guide funnel (11) includes a guide hook (24) for guiding the suspension lines (4) of the traction wing (2).

7. The traction system as claimed in claim 4, wherein the storage neck (17) includes a notch (30) through which the suspension lines (4) of the traction wing (2) pass.

8. The traction system as claimed in claim 4, further including a cover (18) for closing the storage neck (17).

9. The traction system as claimed in claim 1, wherein the deployment and retraction structure passes through the storage window (45).

10. The traction system as claimed in claim 9, wherein the cover includes a cut-out (28) through which the deployment and retraction structure passes.

11. The traction system as claimed in claim 1, further including a wing receptacle (21) attached to the base platform (8) and arranged in the internal storage space (20).

12. The traction system as claimed in claim 11, wherein the wing receptacle (21) includes an upper opening (35) fixed by its perimeter to the internal walls of the storage neck (17).

13. The traction system as claimed in claim 11, further including a driving device for driving in rotation a lower part of the wing receptacle (21).

14. The traction system as claimed in claim 11, wherein the wing receptacle (21) includes a lateral opening (31) for access to the deployment and retraction structure.

15. The traction system as claimed in claim 1, further including a driving device for driving rotation of the base platform (8) on the stand (12) including a toothed ring (42) with which at least one gear (43) meshes.

16. The traction system as claimed in claim 1, further including retaining blocks (44) for holding the base platform (8) against the stand (12).

17. The traction system as claimed in claim 1, further including a retaining leg structure (16) connecting the deployment and retraction structure to the base platform (8) over the storage window (45).

18. The traction system as claimed in claim 5, wherein the guide funnel (11) is formed of at least one barrier (22) attached to the retaining leg structure (16).

19. The traction system as claimed in claim 1, wherein the deployment and retraction structure includes a mooring mast (7) fixed to the base platform (8) and adapted to moor the traction wing (2) by its leading edge.

20. The traction system as claimed in claim 19, wherein the deployment and retraction structure includes carriages (46) for manipulating the suspension lines (4), said carriages (46) being adapted to slide along the mooring mast into the internal storage space (20).

21. A method for deployment or retraction of a traction wing of a traction system as claimed in claim 1, the method including the step of rotating the base platform (8) on the stand (12) to orient the deployment or retraction device relative to the wind.

22. A method of folding a traction wing as claimed in claim 21 further comprising the following steps:
the carriages (46) catch the traction wing (2) by its suspension lines (4);
the carriages (46) descend along the deployment and retraction structure into the internal storage space (20).
